(19) United States
(12) Patent Application Publication
(10) Pub. No.: US 2026/0153191 A1
(43) Pub. Date: Jun. 4, 2026

(54) SYSTEM AND METHOD FOR COOLING OF A LIQUEFIED GAS PRODUCT

(71) Applicant: AZANE FUEL SOLUTIONS AG, SANDEF JORD (NO)

(72) Inventors: Jørn Magnus Jonas, Husøysund (NO); Stian Magnusson, Oslo (NO)

(21) Appl. No.: 18/710,545

(22) PCT Filed: Nov. 18, 2022
(86) PCT No.: PCT/NO22/50267

§ 371 Date: May 15, 2024

(30) Foreign Application Priority Data
Nov. 19, 2021 (NO) 20211391

(51) Int. Cl. F17C 5/02

(52) U.S. Cl. CPC F17C 5/02; F17C 2221/01; F17C 2221/035; F17C 2227/0339; F17C 2227/0358; F17C 2250/061

(57) ABSTRACT

The present invention concerns a method and a system for cooling of a gas product. The system comprises a feed line (1a) for feeding gas product to the system and a storage (1) for liquefied gas product. The storage (1) is connected to the feed line (1a). The system also comprises a cooling circuit for indirect cooling of gas product flowing through the feed line (1a) to the storage (1), wherein the cooling circuit includes the gas product as a coolant and wherein the gas product may be a petroleum gas or ammonia.

### TECHNICAL FIELD

The present invention concerns cooling of liquefied gas products. In particular, the invention concerns a system for cooling of a liquefied gas product and a corresponding method. The system includes a vapor compression cooling system comprising two or more circuits operating at different temperature levels.

### BACKGROUND

Zero-or low-emission gases are increasingly used as fuels, particularly for marine applications. Examples of such gas products are natural gas (NG), petroleum gas (PG), ammonia (NH3), and hydrogen (H2). By replacing hydrocarbon-based liquid fuels, these gas products may contribute to meeting local or global greenhouse gas emission standards. One issue with the use of gas products is that these require increased storage volumes, as compared to hydrocarbon-based liquid fuels. Especially for marine applications, on-board gas product storage may occupy valuable space that could otherwise be used for cargo or passengers. This presents a clear economic disadvantage. In order to minimize storage volumes, gas products are therefore often stored at low to very low temperatures, in liquefied condition. Generally, a liquefied gas occupies significantly less storage space compared to the same amount of gas in a compressed state. The gas product is therefore stored in liquefied condition, and subsequently vaporized to be utilized as fuel.

Nevertheless, the low temperature storage of liquefied gas products poses certain technical challenges. When stored in a storage, for instance, ambient heat from the surrounding environment will gradually heat the liquefied gas within the storage. Such heating may occur, notwithstanding thermal insulation provided on the storage. The heat transfer to the liquefied gas creates boil-off gas, leading to a pressure increase within the storage. Boil-off gas may also be created during the transfer of liquefied gas product to and from the storage. Additionally, any pumping action exerted on the liquefied gas product, or any friction occurring between the liquefied gas product and the piping or equipment through which it flows, may create further boil-off gas. In order to maintain a low pressure in the storage, boil-off gas can be released from the storage into a direct vapor-compression cooling cycle. The storage then functions as an evaporator and the boil-off gas is re-liquefied in the direct cooling cycle, before being returned to the storages. Although such a direct cooling cycle is efficient for a stagnant storage, efficiency drops significantly during transfer of gas product to and from the storage, when pressure in the storage may be high. When the storage pressure increases, the pressure difference over the expansion valve of the direct cooling cycle decreases. Thereby the cooling effect of the direct cooling cycle decreases. In order to address these issues, indirect cooling cycles are utilized, where the boil-off-gas is cooled by a coolant in a heat exchanger. In an indirect cooling circuit, there is no direct contact between the coolant and the gas product that is cooled. However, such an indirect cooling cycle requires the use of a coolant, which utilizes further space, requires additional components and thereby increases costs. Thereby resulting in a further economic disadvantage.

Gas product flammability and, in case of NH3, gas product toxicity, is another issue. Human exposure to gas products should generally be avoided. Therefore, an inert gas, such as nitrogen gas, is often used for purging the gas product transfer piping before and after any gas product transfer operations. During purging, nitrogen gas dilutes and removes any remaining gas product from the transfer piping. A downside of such purging is that a certain amount of nitrogen gas becomes mixed with the gas product and ends up in the gas product storage and piping.

Therefore, there is a clear need for an improved system and an improved method for cooling a liquefied gas product within a storage, as well as during the transfer of liquefied gas product to and from the storage. Additionally, the system and method should provide improved separation of nitrogen gas, accumulated in the storage and plant, from the gas product.

### SUMMARY OF THE INVENTION

The present invention concerns a system for cooling of a liquefied gas product according to claim 1. The present invention also concerns the use of the system according to claim 11, and a method for cooling of a liquefied gas product according to claim 12.

### FIGURES

FIG. 1A schematically shows a system for cooling a liquefied gas product according to the invention including a cooling circuit.

FIG. 1B schematically shows details of a heat exchanger utilized int the System according to the invention including a cooling circuit.

FIG. 2A schematically shows a further embodiment of the system according to the invention, including a vent line for a purging gas.

FIG. 2B schematically shows a further embodiment of the system according to the invention, including a pump.

FIG. 3 schematically shows a further embodiment of the system according to the invention, including a direct cooling circuit.

FIG. 4 schematically shows a further embodiment of the system according to the invention, including a direct cooling circuit and a second compressor.

FIG. 5 schematically shows a further embodiment of a system according to the invention, including a branched outflow line.

FIG. 6 schematically shows a further embodiment of a system according to the invention, including a branched outflow line, a branched feed line and an optional blower.

FIG. 7 schematically shows a further embodiment of a system according to the invention, including a direct cooling circuit, a branched outflow line, a branched feed line and a blower.

### DETAILED DESCRIPTION

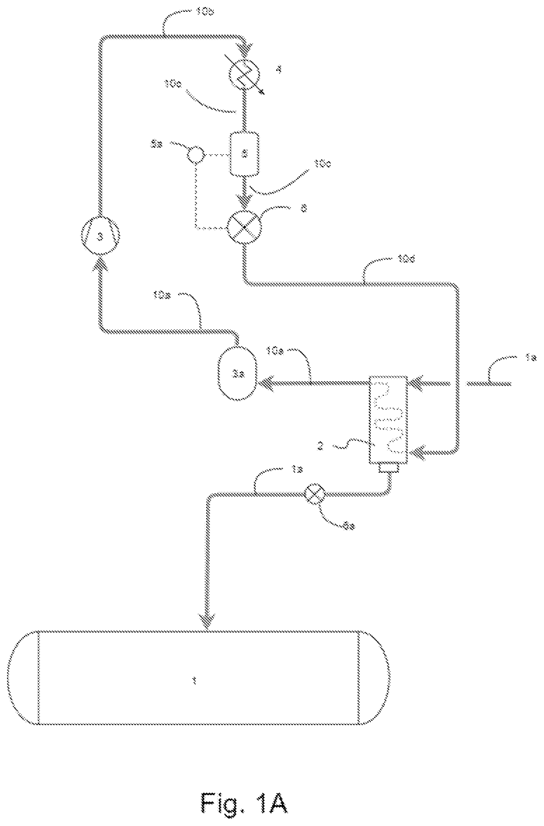

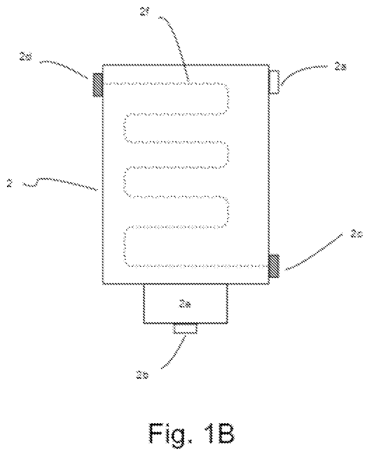

FIG. 1A schematically shows a system for cooling a gas product according to the present invention. The same reference signs denote the same features in FIG. 1A and in all other figures. The system includes at least one storage 1 for a liquefied gas product and a cooling circuit (described below). The cooling circuit includes the gas product as a coolant. Preferably, the coolant consists of the gas product. The storage 1 includes insulation, such as vacuum panel insulation, foam panel insulation, or the like. The storage 1 may be a land-based storage, a vehicle-based storage, or a vessel-based storage. The storage may comprise a tank, a bi-lobe tank, or a multi-lobe tank. The liquefied gas product may be a liquefied petroleum gas (LPG), or a liquefied ammonia (LNH3). Preferably, the liquefied gas product is stored in the storage 1 at a pressure of around 1 bar. The storage 1 may further include a vent, for venting vapor from the storage 1. The system further includes a feed line 1a, for receiving a feed of gas product from an external source. Thereto, the feed line 1a may be provided with a suitable coupling, for coupling to the external source. The external source may be a vessel, a transport vehicle, an iso container, an external storage, or a plant. The feed line 1a is connected to the storage 1. Alternatively, the feed may be a vapor or a liquefied gas product from a recirculation loop, originating from the storage 1 (described further below). The storage 1 further includes an outflow line (described further below) for the transfer of liquefied gas product from the storage 1. For the present embodiment and all following embodiments, the connection between flow lines may include a T-piece, a Y-piece, a pipe spool, or a similar connection means.

The system further includes a heat exchanger 2. The heat exchanger 2 is connected to the storage 1 by the feed line 1a. The general flow direction through the feed line 1a, and through other flow lines in the system, is indicated by an arrowhead (see FIG. 1A and following figures). Details of the heat exchanger 2 are schematically shown in FIG. 1B. The heat exchanger 2 includes a feed inlet 2a, a feed outlet 2b, a coolant inlet 2c and a coolant outlet 2d. The feed inlet 2a and the coolant outlet 2d are preferably located at a top part of the heat exchanger 2. The feed outlet 2b and coolant inlet 2c are preferably located at a bottom part of the heat exchanger 2. The heat exchanger 2 preferably includes a liquid collection container 2e, located at the bottom part. The feed inlet 2a is connected to the feed outlet 2b, by a feed channel (not shown in FIG. 1B for the sake of legibility). The coolant inlet 2c is connected to the coolant outlet 2d, by the coolant channel 2f. The feed channel and the coolant channel 2f are separated In operation, coolant entering the heat exchanger 2 through the coolant inlet 2c passes through the coolant channel of the heat exchanger 2. Gas product in the form of condensate vapor may flow through the feed channel, from the feed inlet 2a to the feed outlet 2b, while being cooled by the coolant.

The system further includes a compressor 3. The inlet side of the compressor 3 is connected to the heat exchanger 2 by a first flow line 10a. The system further includes a second heat exchanger 4. The outlet side of the compressor 3 is connected to the second heat exchanger 4 by a second flow line 10b. In operation, flow enters the compressor 3 from the first flow line 10a and compressed flow exits the compressor 3 into the second flow line 10b. The compressor 3 may be a dynamic type compressor. Advantageously, a dynamic type compressor is less sensitive to droplets entrained within the flow. Alternatively, the compressor 3 may be a positive displacement type compressor. The compressor 3 may be driven by electrical power, or by a hydraulic power unit.

The system may include an optional drum 3a (shown in FIG. 1A), arranged between the heat exchanger 2 and the compressor 3. The drum 3a is connected to the heat exchanger 2 and to the compressor 3 by the first flow line 10a. Preferably, the first flow line 10a and/or the drum 3a have a volume that is sufficient large, such that the compressor 3 may be in continuous operation. The drum 3a is insulated with appropriate insulation.

The system includes a second heat exchanger 4, for condensing the pressurized vapor exiting the compressor 3. In the second heat exchanger 4, cooling water may be used as a coolant. The cooling water may, for instance, be sea water, or water taken from the nearby environment. Alternatively, the coolant in the second heat exchanger 4 may be air. Further alternatively, the coolant in the second heat exchanger 4 may include another cooling fluid or a refrigerant.

The system further includes an expansion valve 6. The expansion valve 6 is connected to the second heat exchanger by a third flow line 10c. The expansion valve 6 is connected to the heat exchanger 2 by a fourth flow line 10d. The system may include an optional receiver 5, arranged between the second heat exchanger 4 and the expansion valve 6. The optional receiver 5 is a collecting vessel, for collecting condensate. The receiver 5 may preferably include a liquid level detector 5a, for detecting liquid levels within the receiver 5. The liquid level detector 5a may be connected to a control unit (not shown).

The system may further include a second expansion valve 6a for regulating the pressure of the feed flow within the heat exchanger 2. The second expansion valve 6a is arranged on the feed line 1a, between the heat exchanger 2 and the storage 1. In operation, the second expansion valve 6a can be controlled to open for expansion after a threshold pressure in the heat exchanger 2 is reached. Advantageously, by regulating the pressure in the feed flow within the heat exchanger, condensation of gas product vapor within the heat exchanger is further increased, by the Joule-Thomson effect. Condensation is therefore enhanced both by lowering the temperature and by increasing the pressure of the feed flow.

Together, the heat exchanger 2, compressor 3, second heat exchanger 4, expansion valve 6, and the first to fourth flow lines, 10a-10d, form the cooling circuit. The cooling circuit includes gas product as a coolant. Preferably, the coolant consists of the gas product. The cooling circuit may include a coolant feed line (not shown), for feeding coolant into the cooling circuit. The coolant feed line may connect the feed line 1a with the cooling circuit. Alternatively, the coolant feed line may connect the storage 1 with the cooling circuit. Further alternatively, the coolant feedline may connect the outflow line 11a with the cooling circuit. The coolant feed line preferably includes a valve, for controlling the flow of coolant into the cooling circuit. The coolant feed line may, for instance, be connected to the cooling circuit at fourth flow line 10d. The cooling circuit is an indirect cooling circuit. In operation, an indirect vapor-compression cooling cycle takes place in the cooling circuit. The indirect vapor-compression cooling cycle (detailed below) includes compression, condensation, expansion-cooling, and evaporation of the coolant. Compression takes place in the compressor, condensation takes place in the second heat exchanger 4, expansion-cooling takes place in the expansion valve 6 and evaporation takes place in the heat exchanger 2. Advantageously, by separating the cooling circuit from the feed line, the pressure in the evaporation stage is independent of the pressure in the storage. Consequently, a higher cooling efficiency can be achieved during transfer of gas product to and from the storage, as compared to a direct cooling cycles, where the storage pressure is influenced by external sources during gas product transfer. Further advantageously, the disadvantages of utilizing an external coolant in an indirect cooling cycle, such as additional requirements for space, components, and costs, are avoided.

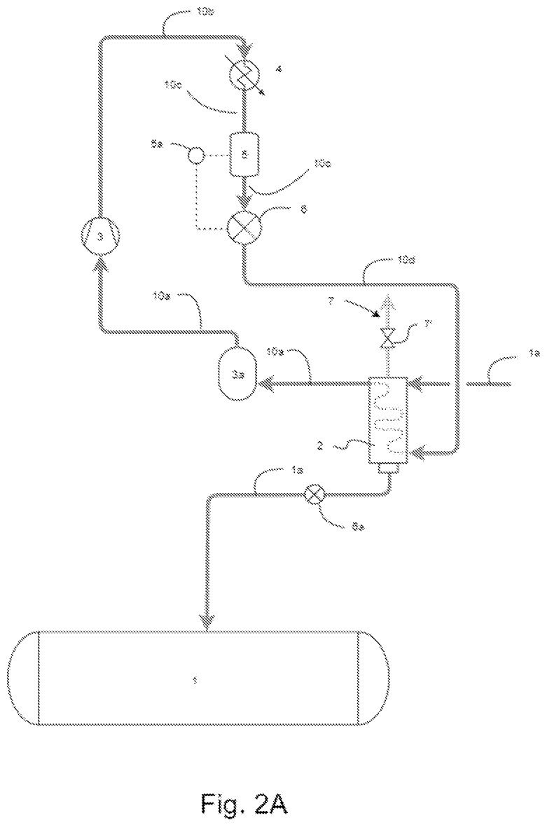

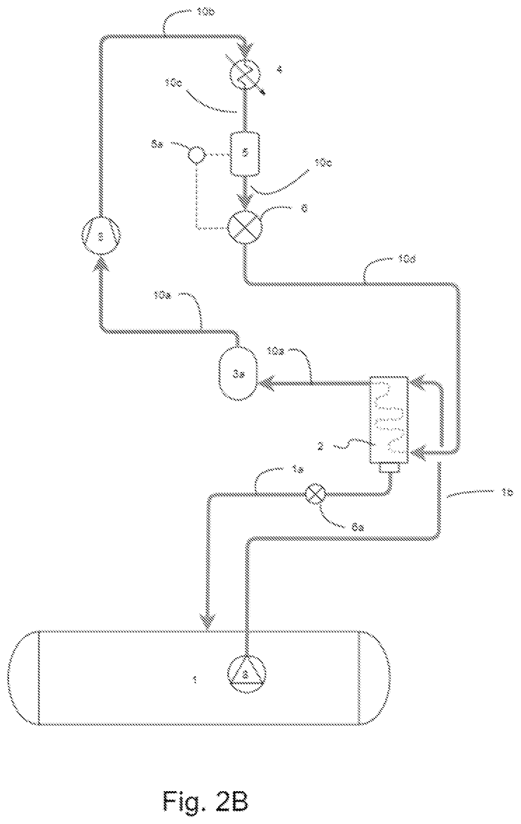

Further embodiments are schematically shown in FIGS. 2A and 2B. In each of these embodiments optional elements described with reference to FIG. 1A may be included. As schematically shown in FIG. 2A, a vent line 7 for separating a purging gas from the gas product may be connected to the heat exchanger 2. As described hereinbelow, separation is preferably achieved by utilizing a purging gas with a boiling temperature well below the boiling temperature of the gas product, at atmospheric pressure. The vent line 7 is connected to the feed flow channel of the heat exchanger 2. Preferably, the vent line 7 includes a control valve 7′. The control valve 7′or the vent line 7 may include a pressure sensor (not shown). In operation, the control valve 7′may be opened, based on a signal from the pressure sensor, when a certain high-pressure value is reached within the feed flow channel and remain closed otherwise. Thereby, the feed flow channel of the heat exchanger 2 acts as a separator. Vapor flow originating from an external source, or originating as boil-off-gas from the storage 1, forms the inlet flow to the separator. The vent line 7 forms the outlet flow connection of the separator. The portion of the feed line la extending between the heat exchanger 2 and the storage 1 forms the bottom flow connection of the separator. The receiver 5 may include an additional vent line (not shown), for venting of purging gas from the cooling circuit.

A further configuration of the system is schematically shown in FIG. 2B. In this configuration the storage 1 includes a pump 8, for circulating liquefied gas product between the storage 1 and the heat exchanger 2. Thereto, a second feed line 1b extends from the pump 8 to the heat exchanger 2. The second feed line 1b is connected to the feed inlet 2a. In operation, liquid gas product may be pumped by the pump 8 from the storage 1 to the heat exchanger 2. In the heat exchanger 2, the liquefied gas product is cooled or subcooled by the cooling circuit and returned to the storage 1 through the feed line 1a. When the vapor pressure in the storage 1 is high, for instance due to the liquefied gas product inside the storage being warm, subcooled liquefied gas product comprising droplets, returning from the heat exchanger 2 is preferably sprayed into the ullage space of storage 1.

Thereto, the outlet of the feed line 1a into the storage 1 may include a spray nozzle. Cooled or subcooled liquefied gas product droplets are thereby mixed with vapor inside the storage 1. Consequently, heat exchange takes place between the subcooled droplets and the vapor, such that the vapor in the storage 1 is cooled. Thereby, the vapor inside the storage is condensed, reducing the pressure within the storage 1. Advantageously, a fast reduction of the vapor pressure in the storage can thereby be achieved. Further advantageously, top spraying of cooled liquid in the ullage space of a storage is a highly effective cooling method when the vapor pressure, and thus the vapor temperature, in the storage is relatively high.

The high vapor pressure causes a higher degree of evaporation between the (sub)cooled droplets and the vapor. During evaporation, heat is taken from the liquid phase, thereby resulting in a cooler liquid phase. This effect is advantageously enhanced by building-up pressure in the storage by utilizing, e.g., a blower in the feed line (detailed below).

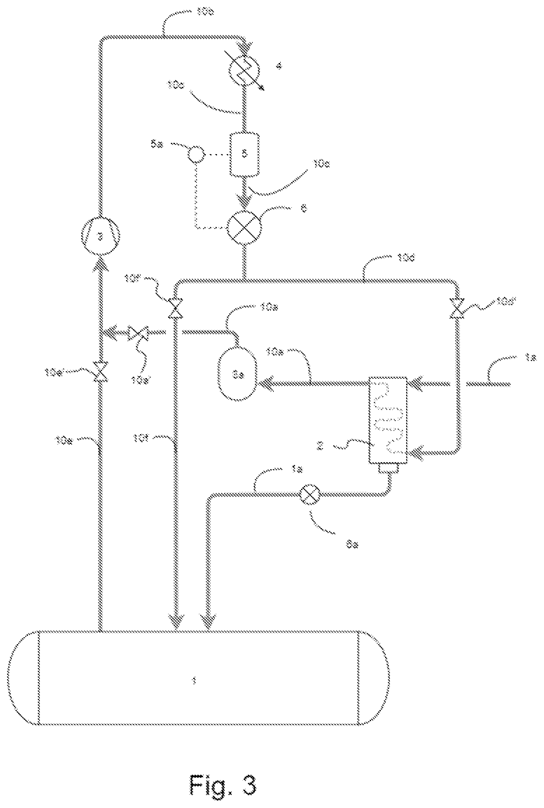

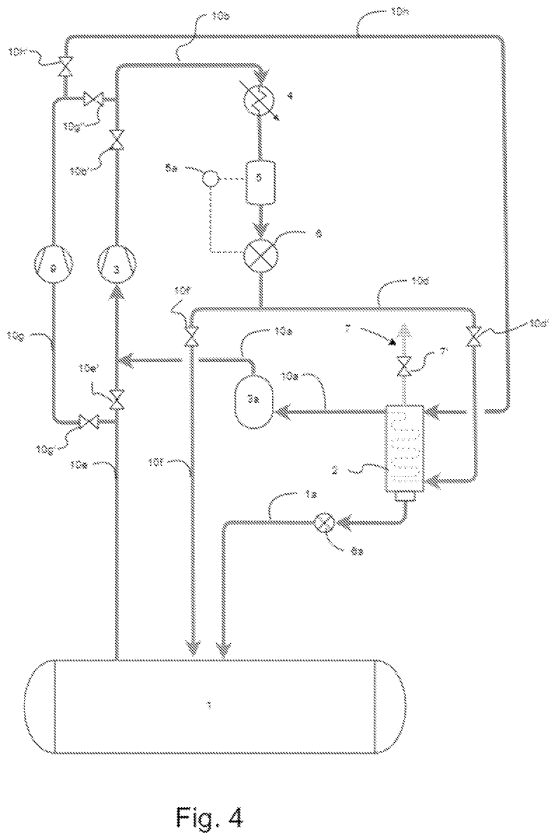

Further embodiments are schematically shown in FIGS. 3 and 4. In each of these embodiments optional elements, described with reference to FIGS. 1A, 2A and 2B, may be included. A further embodiment including a direct cooling circuit is schematically shown in FIG. 3. Components of the system in this further embodiment are as detailed above, for FIG. 1A. Additionally, in this further embodiment the system includes a fifth flow line 10e, extending from the storage 1 to the compressor 3, more specifically, to the inlet side of the compressor 3. The connection between the fifth flow line 10e and the first flow line 10a, may preferably be arranged between the optional drum 3a and the compressor 3. The fifth flow line 10e preferably includes a control valve 10e'. The system also includes a sixth flow line 10f, extending from the outlet side of the expansion valve 6 to the storage 1. Preferably, the end part of the sixth flow line 10f extending into the storage 1 comprises a spray nozzle. The sixth flow line 10f may be directly connected to the outlet side of the expansion valve 6. Alternatively, the sixth flow line 10f may be connected to the fourth flow line 10d, where the connection is arranged between the expansion valve 6 and the heat exchanger 2. The sixth flow line 10f preferably includes a control valve 10f′. Furthermore, the first flow line 10a preferably includes a control valve 10a′. Preferably, the control valve 10a′ of the first flow line 10a is arranged between the optional drum 3a and the compressor 3. Additionally, the fourth flow line 10d preferably includes a control valve 10d′.

Together, the storage 1, compressor 3, second heat exchanger 4, expansion valve 6, the fifth flow line 10e, the second flow line 10b and the sixth flow line 10f, form the direct cooling circuit. Advantageously, the additional flow lines and control valves allow direct cooling of vaporized gas product from the storage, through a vapor-compression cycle. Further advantageously, the system can alternate between the direct cooling cycle and the indirect cooling cycle, without utilizing additional components or an additional coolant.

A further embodiment, including a direct cooling circuit and at least a second compressor 9, is schematically shown in FIG. 4. Other components of the system are as detailed above, for FIG. 3. The compressor 3 and the second compressor 9 may be operated independently, or co-dependently. The second compressor 9 may form a part of an auxiliary direct cooling circuit (described below). Advantageously, the cooling circuit and the auxiliary direct cooling circuit may be driven simultaneously, as opposed to prior art vapor-compression cooling processes, where two or more compressors normally supply high-pressure vapor to one cooling circuit. Further advantageously, as each compressor drives a different cooling circuit, each cooling circuit may have different thermodynamic characteristics, such as different cooling temperatures. The pressure in each cooling circuit is therefore independent from the other cooling circuit. A high cooling efficiency can thus be achieved, even when the vapor pressure in the storage is high.

With reference to FIG. 4, a seventh flow line 10g may connect the fifth flow line 10e with the inlet side of the second compressor 9. Preferably, the connection between the seventh flow line 10g and the fifth flow line 10 e is arranged between the storage 1 and the control valve 10e′ of the fifth flow line 10e. Thereby, flow from the storage 1 to the second compressor 9 can be established, even when the control valve 10e′ in the fifth flow line 10e is closed. The seventh flow line 10g may further connect the outlet side of the second compressor 9 to the second flow line 10b. Thereby, a flow from the second compressor 9 to the second heat exchanger 4 can be established. A further control valve 10g″ may be arranged on the seventh flow line 10g, between the outlet side of the second compressor 9 and the second flow line 10b. Additionally, a control valve 10b′ may be arranged on the second flow line 10b, between the compressor 3 and the connection to the seventh flow line 10g. The present embodiment preferably includes a vent line 7, for venting of a purging gas, as described hereinbefore for FIG. 2A. A purging gas can advantageously be removed from the product gas, through the vent line.

With continued reference to FIG. 4, an eight′ flow line 10h may connect the seventh flow line 10g with the feed inlet 2a of the heat exchanger 2 (shown), or with the feed line 1a. The connection between the seventh flow line 10g and the eight′ flow line 10h is preferably arranged between the second compressor 9 and the second control valve 10g″ of the seventh flow line 10g. A control valve 10h′ may be arranged in the eight′ flow line 10h. Together, the storage 1, second compressor 9, heat exchanger 2, second expansion valve 6a, fifth flow line 10e, seventh flow line 10g, eight′ flow line 10h, and feed line 1a form an auxiliary direct cooling circuit.

Generally, the capacity of a vapor-compression cooling circuit is a function of the compressors capacity to suck a mass flow through the circuit. In the present embodiment an increased mass flow into the compressor is achieved when the liquefied gas product in the storage is relatively warm. The relatively high vapor pressure, arising due to the warm storage, increases the mass flow into the compressor, thereby increasing the capacity of the cooling circuit. On the other hand, the return flow to the storage 1 includes subcooled condensate, due to the low temperature in the first heat exchanger 2 and the increased pressure in the storage 1. The cooled or subcooled condensate has a lower temperature than the saturation temperature inside the storage 1. Evaporation of(sub)cooled condensate returning from the auxiliary cooling circuit will occur when the condensate comes into contact with (relatively) warm vapor in the storage 1. As described hereinbefore, cooling is thereby achieved, lowering the pressure inside the storage 1. For example, when storing liquefied NH3, NH3 vapor with a high vapor pressure is utilized in the auxiliary cooling circuit. The restriction in cooling temperature when returning the flow to the storage 1 is mitigated by cooling action of the auxiliary cooling circuit. In the auxiliary cooling circuit, condensate is subcooled in the heat exchanger 2, before returning to the storage 1. The subcooled condensate is preferably sprayed into the ullage space of the storage 1, wherein the subcooled NH3 condensate mixes with remaining NH3 vapor inside the storage 1 and condenses the NH3 vapor.

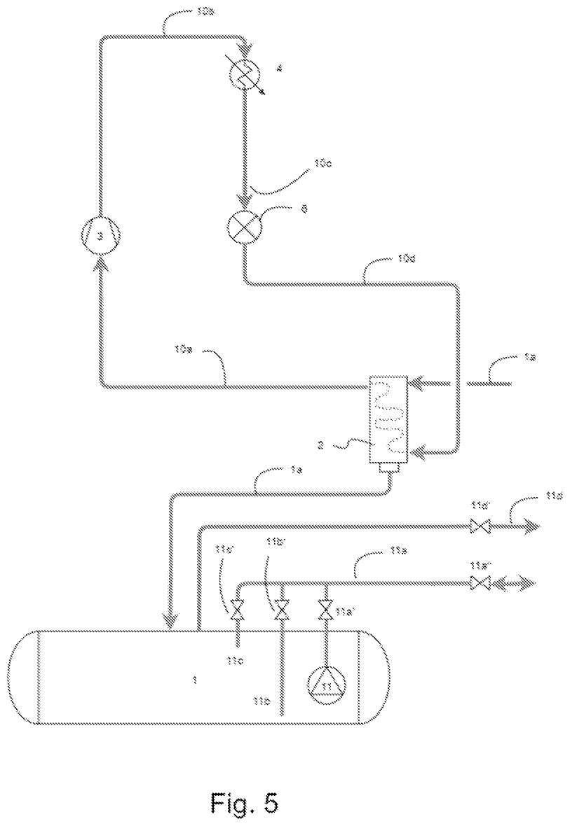

Various feed line and/or outflow line configurations are schematically shown in FIG. 5-7. The configurations in FIG. 5-7 may be combined with any of the embodiments described before, for FIG. 1A-4. For the sake of legibility optional elements appearing in FIG. 1A-4 are omitted from FIG. 5-7 . In a first configuration, FIG. 5, the system includes at least one outflow line 11a. The outflow line 11a may connect the storage 1 with a gas product consumer, a gas product transporter, or an external gas product storage. Thereto, the outflow line 11a may be provided with a suitable coupling, for coupling to the consumer, the transporter, or the external storage. The gas product consumer may be a vessel, a vehicle, a train, a plane, a power station, a fuel station, or a plant, utilizing the gas product. The gas product transporter may include a vessel, a lorry, or a railway carriage, including a temporary storage space for storing liquefied gas product during transport. Alternatively, the outflow line 11a may function as a feed line and connect the storage 1 to an external source. The outflow line 11a may include a first control valve 11a′, for regulating the flow of liquefied gas product therethrough. Optionally the outflow line 11a may include a second control valve 11a″. The storage 1 may further include a pump 11, connected to the outflow line 11a. The pump 11 may drive the flow of liquefied gas product from the storage 1 through the outflow line 11a. Optionally, the outflow line 11a may include a first branch 11b and/or a second branch 11c. The first branch may include a control valve 11b′. The second branch 11c may include a control valve 11c′. The first branch 11b extends from the outflow line 11a into the bottom part of the storage 1. The second branch 11c extends from the outflow line 11a into the top part, or ullage part, of the storage 1. In operation, the first control valve 11a′ on the outflow line 11a may be closed and the control valve 11a″ on the outflow line 11a may be opened. The outflow line 11a may then function as an auxiliary feed line, for feeding of liquefied gas product from an external source directly to the storage 1. Finally, the system may include a vapor outflow line 11d, for the outflow of gas product vapor directly from the storage 1. The vapor outflow line 11d may include a control valve 11d′. Advantageously, the system may thereby simultaneously receive a gas product vapor, through the feed line 1a, and a liquefied gas product, through the outflow line 11a. Alternatively, the system may simultaneously receive a gas product vapor, through the feed line 1a, and feed a liquefied gas product to a consumer or transporter, through the outflow line 11a. The liquefied gas product may be fed to the liquid in the storage 1 through the first branch 11b, may be sprayed on top of the liquid in the storage 1 through the second branch 11c, or both. The outlet of the second branch 11c into the storage may thereto include one or more spray nozzles.

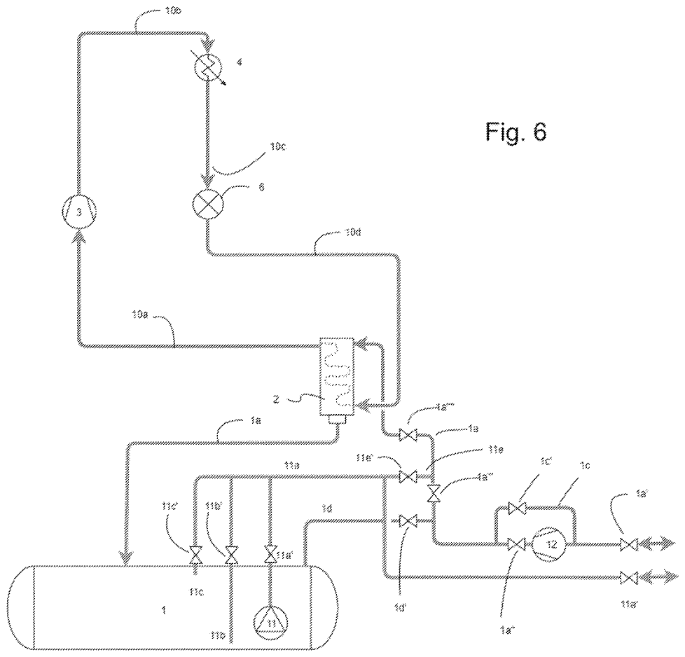

A further configuration is schematically shown in FIG. 6. In this configuration, where other elements are the same as for FIG. 5, the feed line 1a may include a blower 12 and, optionally, a bypass feed line 1c. The flow through the feed line 1a may bypass the blower 12 through the bypass feed line 1c. The feed line 1a may further include a branch-off feed line 1d, extending from the feed line 1a to the storage 1. Furthermore, the system may include a cross-connection 11e between the feed line 1a and the outflow line 11a. The cross connection 11e may include a control valve 11e′. The bypass feed line 1c includes a control valve 1c′. The branch-off feed line 1d also includes a control valve 1d′. The feed line 1a includes a first control valve 1a′, arranged between the external source and the blower 12. The feed line 1a also includes a second control valve 1a″, arranged between the blower 12 and the heat exchanger 2. The feed line 1a further includes a third control valve 1a″′, arranged between the second control valve 1a″ and the heat exchanger 2. Preferably, the third control valve 1a″ is arranged between the connection 11d to the branch-off feed line 1d and the heat exchanger 2. Finally, the feed line 1a includes a fourth control valve 1a″″, arranged between the third control valve 1a″′ and the heat exchanger 2. Preferably, the fourth control valve 1a″′ is arranged between the connection to the outflow line 11a and the heat exchanger 2.

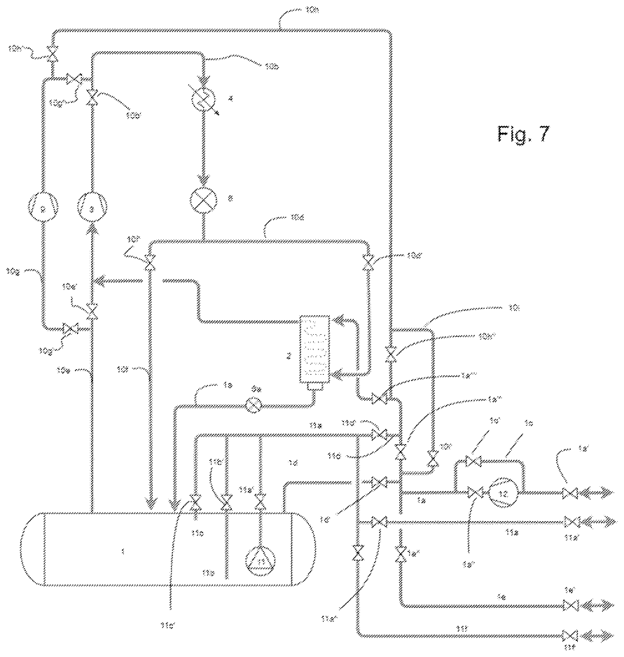

Yet a further configuration is schematically shown in FIG. 7. This configuration includes at least the components previously described with regards to FIG. 4 and FIG. 6. Furthermore, this configuration includes an auxiliary feed line 1e. The auxiliary feed line 1e may be utilized for both inflow of gas product into the system, as well as outflow of gas product from the system. Thereto, the auxiliary feed line 1e may be provided with a suitable coupling, for coupling to an external source, a consumer, a transporter or an external storage. The auxiliary feed line 1e may include a first control valve 1e′ and a second control valve 1e″. The auxiliary feed line 1e may be utilized for both the feeding of gas product to the system, as well as the outflow of gas product from the system. The connection between the auxiliary feed line 1e and the feed line 1a is preferably arranged between the second control valve 1 a″ and the third control valve 1a″. This configuration further includes an auxiliary outflow line 11f. The auxiliary outflow line 11f may be utilized for both the outflow of gas product from the system, as well as the feeding of gas product into the system. Thereto, the auxiliary outflow line 11f may be provided with a suitable coupling, for coupling to an external source, a consumer, a transporter, or an external storage. The auxiliary outflow line 11f may include a first control valve 11f′ and a second control valve 11f″. Additionally, the outflow line 11a includes a second control valve 11a″. The connection between the auxiliary outflow line 11f and the outflow line 11a is preferably arranged between the second control valve 11a″ and the storage 1. Finally, the system includes a further bypass line 10i. The further bypass line 10i connects the eight′ flow line 10h with the feed line 1a. The further bypass line 10i preferably includes a control valve 10i′. Consequently, in the present configuration, the system includes at least four lines 1a, le, 11a, 11f, through which gas product can be fed into the system or out of the system. Advantageously, the system therefore allows for increased flexibility during transfer of gas product into and out of the system.

With reference to FIG. 1A, a method for cooling of a gas product according to the present invention includes providing a system according to the invention, providing a feed flow of gas product or gas product vapor to the storage 1 and cooling the feed flow in the heat exchanger 2, before the feed flow enters the storage 1. Cooling is regulated by the indirect vapor-compression cooling cycle. The cooling cycle utilizes the gas product as a coolant. Preferably, the coolant consists of the gas product. Coolant may be fed to the cooling circuit through the coolant feed line (not shown). Coolant may for instance be fed into the fourth flow line 10d, while the expansion valve 6 is closed. Coolant levels in the receiver 5 are preferably monitored to control the inflow of coolant into the cooling circuit. The feed flow may include a liquefied gas product and/or a gas product vapor. The gas product preferably includes LNH3 or LPG. The feed flow originates from an external source, such as a vessel, a transport vehicle, an iso container, an external storage, or a plant. Preferably, the liquefied gas product is stored in the storage 1 at a pressure of around 1 bar.

The indirect vapor-compression cooling cycle includes compression of the coolant flow by the compressor 3. The compressor 3 sucks coolant vapor through the first flow line 10a from the optional drum 3a. Pressurized coolant vapor exits the compressor 3 and flows to the second heat exchanger 4. The indirect cooling cycle further includes coolant condensation in the second heat exchanger 4, where the vapor is cooled and condensed. The condensate may be collected in the optional receiver 5. Liquid in the optional receiver 5 is preferably at condensation temperature. Consequently, the liquid and the vapor in the receiver 5 are in balance, at saturation temperature and saturation pressure. Lowering of the pressure in the optional receiver 5 creates an unbalance between the liquid and the vapor residing in the receiver 5. The liquid is then no longer in saturated condition and evaporates until the liquid has been cooled to its new saturation temperature. Consequently, the lower the pressure of the flow exiting the expansion valve 6, the lower the temperature of said flow. Expansion-cooling takes place across the expansion valve 6. Evaporation occurs in the heat exchanger 2.

The control unit may control the operation of the expansion valve 6, based on data received from the liquid level detector 5a. The control unit may transmit a control signal for opening or closing of the expansion valve 6. The expansion valve 6 is regulated such that condensate, and not vapor, is expanded through expansion valve 6. The condensate is expanded to a lower pressure on the outlet side of the expansion valve 6. The flow exiting the expansion valve 6 thereby includes a mixture of condensate and vapor. The flow then passes through the coolant channel 2f of the heat exchanger 2, where condensate within the flow is vaporized. By regulating the compressor 3, the pressure on the suction side of the heat exchanger 2 can be adjusted. Thereby the compressor controls the flow rate through the heat exchanger 2 and the pressure difference over the expansion valve 6. The cooling rate and temperature are, in turn, determined by the flow rate and pressure difference. The flow of coolant within the cooling circuit is therefore driven by pressure difference, from the expansion valve 6 to the first flow line 10a and the optional drum 3a. The pressure in the first flow line 10a and the optional drum 3a is the lowest in the cooling circuit and is controlled by the compressor 3. Advantageously, cooling by the indirect vapor-compression cooling cycle is thereby controlled by the compressor and not influenced by pressure variations within the storage, as is the case for known direct cooling cycles. Further advantageously, the cooling circuit uses the gas product as a coolant, thereby avoiding the use of a separate coolant and the logistical and economical disadvantages associated thereto.

Gas product, or liquefied gas product, that is re-circulated from or to the storage 1, may be cooled or sub-cooled by the cooling circuit. Likewise, gas product vapor or liquid gas product, deriving from an external source, may be cooled or sub-cooled by the cooling circuit. Furthermore, vaporized gas product that is transferred to the storage 1 may preferably condense due to cooling by the cooling circuit. Advantageously, the condensate, the cooled fluid, and/or the sub-cooled fluid contribute to a lowering of the temperature in the storage 1 when transferred thereto. Thereby, the pressure in the storage is decreased. This is especially advantageous during the transfer of gas product to the storage.

With reference to FIG. 2A, the method may further include separating a purging gas, such as N2, from a gas product, such as NH3. The purging gas is vented from the heat exchanger 2, through a vent line 7. As described hereinbefore, the heat exchanger 2 forms a separator for the mixture of gas product and purging gas. The separator is cooled and pressurized to enhance the separation of purging gas from the gas product.

As a working example, with continued reference to FIG. 2A or 4, when nitrogen gas (N2) is used for purging or cleaning of flow lines before and after transfer of NH3 to the storage 1, mixing of N2 with NH3 may be unavoidable. At atmospheric pressure, N2 has a boiling point of −196° C. whereas NH3 has a boiling point of −33,3° C. The feed channel of the heat exchanger 2 serves a separator, for separating N2 from NH3. The coolant flowing through the heat exchanger 2 cools the feed channel, or separator, of the heat exchanger 2. Normal temperature at the feed outlet 2b is −33° C. The separator volume may therefore be cooled to a temperature of less than 10° C., preferably less than 5° C., most preferably less than 3° C. above the normal temperature at the feed outlet 2b. Consequently, NH3 is close to its condensation temperature, when the separator is at atmospheric pressure. Any increase in separator pressure may cause condensation of NH3 vapor in the separator. Such pressure increase may occur due to, e.g., the action of a blower (detailed above) arranged in the feed line 1a, due to throttling of the second expansion valve 6a, or due to other reasons leading to a high vapor pressure in the storage 1. On the other hand, N2 is in its gas phase, far from its boiling or condensation temperature, under practical operational conditions in the separator. Consequently, N2 gas can be vented through the vent line 7, thereby separating the purging gas N2 from the gas product NH3 in the system.

With reference to FIG. 3, a further embodiment of the method is next described. The control valve 10a′ in the first flow line 10a and the control valve 10d′ in the fourth flow line may be closed when there is no feed flow to, or from, the storage 1. Control valve 10e′ in the fifth flow line 10e and control valve 10f′ in the sixth flow line 10f may then be opened. Vaporized gas product from the storage 1 may then flow from the storage 1 through the fifth flow line 10e directly to the compressor 3, to be pressurized. The pressurized gas product vapor is then condensed in the second heat exchanger 4, before being expansion-cooled in the expansion valve 6. Thereby the gas product vapor from the storage 1 flows through the direct cooling circuit and undergoes a direct vapor-compression cooling cycle. From the expansion valve 6 the expansion-cooled gas product condensate flows back into the storage 1, through the sixth flow line 10f. Consequently, the evaporation stage of the direct vapor-compression cooling cycle is achieved through evaporation in the storage 1. Alternatively, during transfer of gas product from or to the storage 1, the control valve 10e′ in the fifth flow line 10e and the control valve 10f′ in the sixth flow line 10f may be closed. The control valve 10a′ in the first flow line 10a and the control valve 10d′ in the fourth flow line 10d may then be opened and an indirect vapor-compression cooling cycle, as described hereinbefore for FIG. 1A, may commence. Consequently, the method can alternate between the indirect cooling cycle, during transfer of gas product to and/or from the storage 1, and the direct cooling cycle, when there is no transfer to and/or from the storage 1.

With reference to FIG. 4, a further embodiment of the method is described. In this embodiment, the control valve 10b′ on the second flow line 10b and the control valve 10e′ on the fifth flow line 10 e may be closed. The control valve 10g′ and the second control valve 10g″ on the seventh flow line 10g, as well as the control valve 10f′ on the sixth flow line 10f, may be opened. Thereby, a direct cooling circuit may be established, with flow from the storage 1 to the second heat exchanger 4, driven by the second compressor 9. After passing the second heat exchanger 4, the optional receiver 5, and the expansion valve 6, the expansion-cooled flow may be directed back to the storage 1, through the sixth flow line 10f. The direct cooling is driven by the second compressor 9. Thereby, a direct cooling cycle with a cooling temperature according to the pressure in the storage 1 is achieved. Advantageously, direct cooling may thereby be driven even when the compressor is off-line.

With continued reference to FIG. 4, yet a further embodiment of the method is described, where the control valve 10g′ of the seventh flow line 10g and the control valve 10h′ of the eight′ flow line 10h may be opened. The control valve 10e′ of the fifth flow line 10 e and the second control valve 10g″ on the seventh flow line 10g may be closed. The second compressor 9 may then drive flow of gas product through the auxiliary direct cooling circuit, from the storage 1, to the heat exchanger 2 and back to the storage 1. Thereby an auxiliary direct cooling cycle is performed in the auxiliary direct cooling circuit. The condensing temperature in the auxiliary direct cooling cycle is controlled by the indirect cooling cycle (described hereinbefore, in connection with FIG. 1A). The compressor 3 may drive flow through the cooling circuit, thereby driving the indirect cooling cycle.

The method further includes modes for the transfer of gas product to and from the storage 1. The gas product may be in vapor form and/or in liquid form. With reference to FIG. 6, in a first transfer mode an external storage, such as a vessel-based storage, may be filled with liquefied gas product from the storage 1. The control valves on the outflow line 11a are operated so that liquid may be pumped therethrough and into the external storage. At the same time, vapor may flow out from the external storage into the system. The vapor may be pushed out from the external storage by the rising liquid level in the external storage. In addition, boil-off from the liquid in the external storage may add to the vapor flow. The control valves on the feed line 1a are then operated such that the vapor may flow through the heat exchanger 2 and the secondary expansion valve 6a, and into the storage 1. Additionally, or alternatively, the vapor may pass through the blower 12. The blower 12 increases the pressure in the vapor flow. In combination with the cooling temperature in heat exchanger 2 the condition for condensing vapor flowing into the system through the feed line pipe 1a is thereby improved. Due to the increased pressure from the blower 12 and the secondary expansion valve 6a, cooling in the storage 1 is increased. Thereby, vapor originating from the external storage is cooled, and preferably condensed, in the heat exchanger 2. The blower 12 and the secondary expansion valve 6a may further enhance condensation of vapor within the heat exchanger 2, by regulating a build-up of pressure in the heat exchanger 2.

In a second transfer mode, with continued reference to FIG. 6, gas product may be pumped from the external storage, through the outflow line 11a, into the storage 1. Vapor may be evacuated from the external storage through the branch-off feed line 1d. In the first and the second mode, the bypass feed line 1c may be utilized when the blower 12 is off-line, when the pressure of the inflow is such that the blower 12 is not required, or when the feed line 1a is utilized for an outflow of gas product vapor from the system, through the branch-off line 1d.

With reference to FIG. 7, in a third transfer mode, liquid gas product may be transferred from the storage 1 to a gas product consumer, a gas product transporter, or an external gas product storage, through the outflow line 11a. Simultaneously, gas product vapor is returned to the system, through the feed line 1a. Such a simultaneous feeding and outflow may, for instance, occur when a vessel-based storage is supplied with liquid gas product from the system, while gas product vapor from the vessel-based storage is returned to the system. The gas product vapor flows to the storage 1, via the heat exchanger 2. As described hereinbefore, pressure in the heat exchanger 2 is controlled by the expansion valve 6a. Alternatively, or additionally, pressure in the returned gas product vapor flow may be increased by the blower 12. Advantageously, increasing the pressure in the heat exchanger 2, increases cooling efficiency. This is beneficial in all conditions, whether liquid in the storage is cold or warm.

With continued reference to FIG. 7, in a fourth transfer mode, liquid gas product may be transferred from the storage 1 to a gas product consumer, a gas product transporter, or an external gas product storage, through the outflow line 11a. Simultaneously, gas product vapor is returned directly to the storage 1, through the feed line 1a and the branch-off feed line 1d, from an external source. Cooling of the returned gas product vapor and storage 1 is achieved by re-routing a part of the liquid gas product flow out of the storage 1 via the cross connection 11e into the feed line 1a. This part of the liquid gas product flow is cooled or sub-cooled in the heat exchanger 2. After flowing through the heat exchanger 2, the cooled or sub-cooled part of the liquid gas product flow is next sprayed into the ullage space of the storage 1. Advantageously, when the liquid in the storage 1 is warm, cooling is improved with the fourth transfer mode.

With continued reference to FIG. 7, transfer of liquid gas product from an external source to the storage 1 is next described. In a fifth transfer mode, liquid gas product is transferred to the system through the outflow line 11a, the cross connection 11d, and the feed line 1a, into the heat exchanger 2. The liquid gas product is then passed through the heat exchanger 2 and to the storage 1. Simultaneously, gas product vapor flows directly from the storage 1, through the branch-off feed line 1d and the feed line 1a to a gas product consumer, transporter, or external storage. The fifth transfer mode is preferable when feeding warm, pressurized liquid gas product from an external source to the system. Such feeding is preferably driven by an external supply pump.

With continued reference to FIG. 7, in a sixth transfer mode, gas product vapor is transferred from the storage 1 to the second compressor 9. From the second compressor 9 compressed gas product vapor flows out of the system, through the eight′ flow line 10h, the further bypass line 10i and the feed line 1a. The liquid gas product is transferred to the system through the outflow line 11a, the cross connection 11d, and the feed line 1a, into the heat exchanger 2. The sixth transfer mode is advantageous for filling from an external storage with warm, pressurized liquid gas product, when the pressure of the liquid gas product feed stream at the external source is the main driver of the feed flow into the system. In this case the compressor 3 and/or second compressor 9 can regulate the flow from the external source into the system.

With continued reference to FIG. 7, liquid gas product may be transferred directly to the storage 1 in the seventh, the eight and the ninth transfer modes. The liquid gas product flows to the storage 1 through the outflow line 11a and the first outflow line branch-off 11b and/or through the second outflow line branch-off 11c. In a seventh transfer mode, gas product vapor simultaneously flows out from the storage 1, through the branch-off feed line 1d and the feed line 1a, to an external gas product consumer, transporter, or storage. Advantageously, if the gas product vapor flows into an external storage from which liquid gas product is fed into the system, it is ensured that the external storage does not collapse. Furthermore, gas product vapor in the storage 1 may be cooled by operating the direct cooling cycle, utilizing the compressor 3, second heat exchanger 4 and expansion valve 6. The cooled gas product is returned to the storage 1, through the sixth flow line 10f. Advantageously, the seventh transfer mode is suitable for low gas product transfer rates or the transfer of sub-cooled gas products. The seventh transfer mode is further advantageous when the heat exchanger is off-line due to maintenance or other reasons, thereby avoiding the use of the indirect cooling circuit.

With continued reference to FIG. 7, in an eight′ transfer mode, gas product vapor flows to, for example, an external consumer, transporter or storage, via the second compressor 9, through the eight′ flow line 10h, the further bypass line 10i and the feed line 1a. Advantageously, when the external consumer, transporter, or storage is able to handle the gas product vapor received from the storage 1, the eight′ transfer mode allows feeding and outflow with high gas product flow rates. Gas product vapor flows to the external storage, to ensure that external storage does not collapse and/or to ensure that pressure in the storage 1 is maintained. The flow requires a higher flowrate than what storage-pressure at the external storage can provide and is therefore driven by the second compressor.

With continued reference to FIG. 7, in a ninth transfer mode, gas product vapor from the storage 1 is cooled in an indirect cooling cycle and returned in condensed form to storage. Advantageously, efficient cooling of the storage and high flow rates are thereby enabled, even when no gas product vapor is returned to the external storage. The gas product vapor flows from the storage 1 through the fifth flowline 10e and the seventh flow line 10g to the second compressor 9. The pressurized gas product vapor then flows through the eight′ flow line 10h and a portion of the feed line 1a to the heat exchanger 2. In the heat exchanger 2, the gas product vapor is cooled by the indirect cooling cycle. Subsequently, the gas product is returned to the storage 1. Advantageously, the ninth mode of transfer allows cooling and regulating of the pressure in the storage while importing gas product. Thereby faster gas product flow rates are enabled since the coolant is independent of tank pressure. This also enables fast flow rates even when the external storage has no boil-off-gas handling capabilities or atmospheric tanks and requires vapor stream from storage 1 to maintain pressure in external storage.

Alternatively, gas product vapor may flow directly from the storage 1 to the external source, a consumer, a transporter or an external storage. Thereto, the gas product vapor flows through the eight′ flow line 10h, the further bypass line 10i, the feed line 1a and the bypass feed line 1c to exit the system.

### LIST OF REFERENCES

1 storage
1a feed line
1a′ first control valve
1a″ second control valve
1a″′ third control valve
1a″″ fourth control valve
1b second feed line
1c bypass feed line
1c′ control valve
1d branch-off feed line
1d′ control valve
1e auxiliary inflow line
1e′ first control valve
1e″ second control valve
2 heat exchanger
2a feed inlet
2b feed outlet
2c coolant inlet
2d coolant outlet
2e liquid collection container
2f coolant channel
3 compressor
3a drum
4 second heat exchanger
5 receiver
5a liquid level detector
6 expansion valve
6a second expansion valve
7 vent line
7′control valve
8 pump
9 second compressor
10a first flow line
10a′ control valve
10b second flow line
10b′ control valve
10c third flow line
10d fourth flow line
10d′ control valve
10e fifth flow line
10e′ control valve
10f sixth flow line
10f′ control valve
10g seventh flow line
10g′ control valve
10g″ second control valve
10h eight flow line
10h′ control valve
10i further bypass line
10i′ control valve
11 pump
11a outflow line
11a′ control valve
11a″ second control valve
11b first outflow line branch-off
11b control valve
11c second outflow line branch-off
11c′ control valve
11d vapor outflow line
11d′ control valve
11e cross connection
11e′ control valve
11f auxiliary outflow line
11f′ first control valve
11f″ second control valve
12 blower

1. A system for cooling of a gas product, the system comprising:
a feed line for feeding a gas product to the system;
a storage comprising the liquefied gas product, wherein the storage is connected to the feed line; and
a cooling circuit for indirect cooling of gas product flowing through the feed line to the storage; wherein the cooling circuit includes the gas product as a coolant and wherein the gas product comprises petroleum gas or ammonia;
wherein the cooling circuit further includes:
a heat exchanger for vaporizing condensed coolant and for cooling the gas product flowing into the storage, wherein the heat exchanger is connected to the feed line;
a compressor for compressing vaporized coolant exiting the heat exchanger, wherein an inlet side of the compressor is connected to the heat exchanger by a first flow line;
a second heat exchanger, for condensing of compressed coolant exiting the compressor, wherein an outlet side of the compressor is connected to the second heat exchanger by a second flow line; and
an expansion valve for expansion cooling of condensed coolant exiting the second heat exchanger, wherein the expansion valve is connected to the second heat exchanger by a third flow line, and connected to an inlet of the heat exchanger by a fourth flow line.

2. The system of claim 1, further comprising a second expansion valve arranged on the feed line between the heat exchanger and the storage.

3. The system of claim 1, further comprising a drum arranged between the heat exchanger and the compressor.

4. The system of claim 1, further comprising a receiver arranged between the second heat exchanger and the expansion valve, and optionally a liquid level detector for detecting liquid levels within the receiver.

5. The system of claim 1, further comprising a vent line connected to the heat exchanger, wherein the heat exchanger comprises a feed flow channel and the vent line is connected to the feed flow channel, and wherein the vent line optionally comprises a control valve.

6. The system of claim 1, wherein the storage further comprises a pump for pumping liquid gas product and wherein the pump is connected to a feed inlet of the heat exchanger.

7. The system of claim 1, further comprising a direct cooling circuit, the direct cooling circuit comprising:
a fifth flow line extending from the storage to the compressor; and
a sixth flow line extending form the expansion valve to the storage.

8. The system of claim 7, further comprising a second compressor connected to the storage.

9. The system of claim 1, further comprising a blower connected to the feed line.

10. A method of cooling of a gas product, the method comprising:
providing a system according to claim 1
providing a feed flow of gas product through the feed line to the storage; and
cooling the feed flow by the cooling circuit with an indirect cooling cycle before the feed flow enters the storage, wherein the gas product comprises petroleum gas or ammonia.

11. The method of claim 10, wherein a purging gas is separated from the gas product in a heat exchanger.

12. The method of claim 10, wherein liquefied gas product flows from the storage to an external storage through an outflow line, and gas product vapor flows into the storage through the feed line, and wherein the gas product vapor is cooled in the heat exchanger by the indirect cooling cycle.

13. The method of claim 12, wherein pressure of the gas product vapor in the heat exchanger is regulated by the second expansion valve and/or the blower.

14. The method of claim 12, wherein the external storage is a vessel-based storage.

15. The method of claim 10, wherein liquid gas product from an external source flows directly to the storage through an outflow line; and wherein:
gas product vapor flows from the storage to an external consumer, transporter, or storage, via the second compressor; or
gas product vapor flows from the storage through the heat exchanger and is cooled by the indirect cooling cycle, before flowing back to the storage.

16. A method of cooling of a gas product, the method comprising providing a feed flow of gas product to a storage and cooling the feed flow in a heat exchanger, before the feed flow enters the storage; wherein:
cooling is regulated by an indirect vapor-compression cooling cycle utilizing the gas product as a coolant; and
the feed flow includes liquefied ammonia or liquefied petroleum gas.
